(19) United States
(12) Patent Application Publication
(10) Pub. No.: US 2016/0341413 A1
(43) Pub. Date: Nov. 24, 2016

(54) LED LIGHTING DEVICE

(71) Applicants: SHANGHAI SANSI ELECTRONIC ENGINEERING CO.,LTD, Shanghai (CN); SHANGHAI SANSI SCIENCE AND TECHNOLOGY DEVELOPMENT CO.,LTD, Shanghai (CN); JIASHAN SANSI PHOTOELECTRIC TECHNOLOGY CO.,LTD, Jiaxing City, Zhejiang (CN)

(72) Inventors: Bishou Chen, Shanghai (CN); Li Xu, Shanghai (CN); Hui Pan, Shanghai (CN); Jiaguo Cui, Shanghai (CN)

(21) Appl. No.: 15/114,835

(22) PCT Filed: Apr. 23, 2014
(86) PCT No.: PCT/CN2014/076052

§ 371 Date: Jul. 27, 2016

(30) Foreign Application Priority Data
Jan. 27, 2014 (CN) 201410040152.4

(51) Int. Cl. F21V 29/83; F21V 23/02; F21K 9/232; F21V 3/04

(52) U.S. Cl. CPC F21V 29/83; F21V 3/0409; F21V 23/023; F21K 9/232; F21Y 2115/10

(57) ABSTRACT

An LED lighting device includes a base, light-emitting chips, a circuit coating and a lamp shade, wherein the circuit coating is directly coated on the upper surface of the base; the light-emitting chips are directly adhered to the base, and connected with each other through the circuit coating; the lamp shade is arranged on the base and covers the light-emitting chips and the circuit coating. The inner surface of the lamp shade includes a light distribution surface and a thermally-conductive surface, wherein the thermally-conductive surface is at least located at a central region and an edge region of the inner surface. The LED lighting device employs a solid material as the lamp shade, and simultaneously employs a hollow base and cooling holes; therefore, heat generated by the chips can be transferred outwards via the base and the lamp shade, and then taken away by air flowing.

### CROSS REFERENCE OF RELATED APPLICATION

This is a U.S. National Stage under 35 U.S.C 371 of the International Application PCT/CN2014/076052, filed Apr. 23, 2014, which claims priority under 35 U.S.C. 119(a-d) to CN 201410040152.4, filed Jan. 27, 2014.

### BACKGROUND OF THE PRESENT INVENTION

Field of Invention

The invention relates to an LED, and particularly to a new LED lighting device.

Description of Related Arts

Application of LED (light-emitting diode) technology in the lighting system has gradually become a main trend, however, the heat dissipation of LED lighting devices has always been a problem more difficult to solve, and therefore the manufacture of high-power LED devices is limited, to result in that the brightness of single LED light source is insufficient and the size of a display-type LED lighting device is too large. A traditional LED light-emitting unit generally comprises a package part, a light-emitting chip, a light source support (also known as a substrate), a circuit board, and a radiator. It can be seen that, in the traditional LED light-emitting unit, heat generated by the light-emitting chip can be dissipated finally only through a path of “a chip—a light source support—an electrical layer on a surface of a circuit board—a circuit board—a thermally-conductive silicone grease—a radiator” in turn, but a huge heat resistance may be generated in this process. Package materials of traditional techniques commonly employ resin materials, which are poor in thermal conductivity, to cause that the heat generated by the chip cannot be transferred outwards in a direction of the package part and can be conducted only in the direction of the radiator. In addition, in the manufacture of a bulb lamp, the chip usually has a separate package component and then is covered by a hollow outer cover to form a shape of the bulb lamp, so that the heat generated by the chip needs to be transferred into air through the separate package component, then is transferred to the outer cover, and finally is transferred to the surrounding air, to cause that the heat is almost impossible to be transferred outwards. In addition, most of bases of the traditional LED lighting devices commonly employ increased scale to increase the cooling area. However, the cooling results are not very satisfactory. Some newer LED lamps use a hollow base and heat is taken away through air circulation to increase the cooling efficiency and play a good role. However, the LED light-emitting chip generates more heat, so the cooling effect of this method cannot manufacture LED lighting lamps with larger power in a certain volume range.

### SUMMARY OF THE PRESENT INVENTION

For shortcomings in the prior art, a new LED lighting device is provided. The LED lighting device has a better heat dissipation function, thereby realizing a higher power in a smaller size, to achieve the higher lighting brightness without increasing the size of the device.

An LED (light-emitting diode) lighting device according to the invention, comprises: a base, a circuit coating, a plurality of light-emitting chips and a lamp shade, wherein the base has a hollow structure; the circuit coating is directly coated on an upper surface of the base; the light-emitting chips are directly adhered to the base, and connected with each other through the circuit coating; the lamp shade is arranged on the base and covers the LED light-emitting chips and the circuit coating; the lamp shade is a solid component made of a thermally-conductive material; the lamp shade has an outer surface and an inner surface; the outer surface is a light exit surface; the inner surface comprises a light distribution surface and a thermally-conductive surface, wherein, the light distribution surface is arranged on an inner surface region corresponding to the LED light-emitting chips; a gap is formed between the light distribution surface and the LED light-emitting chips, to form a light distribution chamber together with the upper surface of the base; the thermally-conductive surface is arranged on an inner surface part other than a part where the LED light-emitting chips are installed on the base, or an inner surface region corresponding to the entire upper surface, and closely fits with the base; and the thermally-conductive surface is at least distributed in a central region and an edge region of the inner surface.

Preferably, the inner surface of the lamp shade consists of the light distribution surface and the thermally-conductive surface.

Preferably, the lamp shade is made of transparent ceramic or glass.

Preferably, the transparent ceramic is selected from PLZT (Plomb Lanthanum Zirconate Titanate), CaF₂, Y₂O₃, YAG (Yttrium Aluminum Garnet), polycrystalline AION and MgAl₂O₄.

Through repeated experiments, the inventors manufacture the lamp shade by using PC, glass and transparent ceramic respectively. The experimental results show that the junction temperature rise of PC is maximum; the junction temperature rise of the glass lens is 4° C. lower than that of PC, and the junction temperature rise of transparent ceramic lens is 8° C. lower than that PC. Therefore, the invention adopts the ceramic and glass with better thermal conductivity and lower junction temperature rise in use.

Preferably, the circuit coating is a liquid or powder coating containing metal material; a thickness of the circuit coating line layer is 20 μm or above.

Preferably, the metal material of the circuit coating is selected from molybdenum, manganese, tungsten, silver, gold, platinum, silver-palladium alloy, copper, aluminum and tin.

Preferably, the upper surface of the base provided with light-emitting chips is curved or in a shape of multi-planar combination.

Preferably, the outer surface of the lamp shade is made into specific curved shape in accordance with requirements of light distribution; the inner surface in contact with the base is a curved shape or corresponding to the upper surface of the base, in a shape of multi-planar combination.

Preferably, the base has a first cooling hole.

Preferably, the lamp shade has a second cooling hole, wherein, the second cooling hole is correspondingly communicated with the first cooling hole.

Preferably, the base is a metal base coated with an insulating layer, or a base made of an insulating material.

Preferably, the device further comprises a power supply chamber, wherein the power supply chamber may be made of plastic or ceramic materials, and is not communicated with the base, that is a cavity of the power supply chamber is isolated from the base. An outer housing of the power supply chamber and the base can be integrally formed and can also be an independent structure; the outer housing of the power supply chamber and the base are connected in inserting, clamping and screwing modes, to realize independent cooling, so as to reduce the influence of heat generated by chips, and enhance the overall thermal capacity of the entire LED lighting device.

According to the structure of LED lighting device of this invention, because the lamp shade and the base are adhered to each other, heat generated by the LED light-emitting chips can be transferred outwards via the lamp shade and the base. The thermally-conductive surface of the lamp shade is distributed in the central region and edge region of the inner surface, compared with the prior art only having the edge contact, a contact area between the lamp shade and the base is increased, thereby the heat dissipation function of the lamp shade is improved. Inventors of the invention make calculations by computer thermal-simulation software. According to the invention, compared with existing products having the materials, sizes and powers same as those of the LED lighting device of the invention and only having edge contact, the junction temperature rise can be reduced by at least 30° C. In addition, the circuit board is not used in the invention, and the line coating is directly coated on the base, to greatly reduce the thermal resistance and strengthen the cooling effect of the lamp. Meanwhile, because the base is a hollow structure, the base and the lamp shade respectively have a first cooling hole and a second cooling hole; therefore, the entire LED lighting system can realize air circulation in all directions, so that heat transferred to the surface via the lens and base is rapidly taken away by flowing air, to greatly enhance the heat dissipation function of the entire lighting device.

Meanwhile, the experimental results obtained by the inventors through repeated experimental verification completely conform to the results simulated by the computer thermal-simulation software. Therefore, the technical solution of this invention has the breakthrough progress in increasing the heat radiation of the entire LED lighting device.

Compared with the prior art, the invention has the following beneficial effects:

The material having better thermal conductivity is employed as the lamp shade, as a result, heat generated by the chips not only can be dissipated via the base, but also can be transferred outwards via the thermally-conductive surface which is directly adhered to the base and arranged on the inner surface of the lamp shade. In addition, some preferred structures of the invention, such as the cooling hole and hollow base, can further enhance the heat dissipation function, thus allowing the entire device to dissipate heat in all directions, greatly improving the heat dissipation performance of the device, and prolonging the service life of the device. An independently arranged power supply chamber allows the heat generated by the chips and a power supply to be dissipated outwards by different structures respectively, thereby reducing the impact on the power supply caused by the heat generated by the chips, and further reducing the impact on the power supply caused by excessive heat.

Regardless of the installation mode, the products of this invention can achieve 360-degree air circulation in all directions, so as to effectively remove the heat generated by the lamp itself and greatly reduce the junction temperature rise.

Further, due to the improvement of the heat dissipation performance, the lighting device of higher power can be manufactured without increasing the size of the device, and the lighting brightness of the device is improved, while the use range and flexibility of the LED lighting device are improved in life and industrial use.

### BRIEF DESCRIPTION OF THE DRAWINGS

Other features, objects, and advantages of the invention will become more apparent from reading the description of non-limiting embodiments detailed with reference to the following figures:

FIG. 1 is an overall structure diagram of an LED lighting device according to a first embodiment of the invention.

FIG. 2 is a cross-sectional structure diagram of the LED lighting device in FIG. 1.

FIG. 3 is a schematic diagram of a thermally-conductive surface and a light distribution surface of the LED lighting device in FIG. 1.

FIG. 4 is an overall structure diagram of an LED lighting device according to a second embodiment of the invention.

In the drawings:

1 is a base;

2 is a light-emitting chip;

3 is a lamp shade;

31 is a light distribution surface;

32 is a thermally-conductive surface;

4 is a power supply chamber;

51 is a first cooling hole;

52 is a second cooling hole.

### DETAILED DESCRIPTION OF THE PREFERRED EMBODIMENT

The invention is described in detail as follows with reference to specific embodiments. The following embodiments will help provide further understanding of the invention for those skilled in the art, and not in any way limit the invention. It shall be noted that several variants and improvements can be made without departing from concept of the invention for those of ordinary skill in the art. All these fall within the scope of protection of the invention.

An LED lighting device according to the invention, comprises: a base, a plurality of light-emitting chips, a circuit coating, a lamp shade and a power supply chamber. The lamp shade is made of a thermally-conductive solid material with good heat conduction. The light-emitting chips are fixed to the base. The lamp shade is disposed on the base, to cover the light-emitting chips; the lamp shade is in contact with the base by regarding an inner surface other than a corresponding area (i.e., a light distribution surface 31) of the light-emitting chips as a thermally-conductive surface, to achieve the heat dissipation function; the inner surface of the corresponding area of the lamp shade and light-emitting chips forms a specific shape of space structure according to the design needs, to change the light intensity distribution; wherein, the thermally-conductive surface is regarded as a part of the inner surface of the lamp shade, and can participate in light distribution by using light reflection and/or refraction; therefore, technical solutions using the thermally-conductive surface to participate in light distribution also belong to the non-limiting embodiments protected by the invention.

An upper surface of the base is curved or in a shape of multi-planar combination.

The base employs a hollow structure to increase air circulation and enhance heat dissipation, for example, a first cooling hole is arranged in a middle of the base, to increase air circulation and enhance heat dissipation; correspondingly, a second cooling hole is arranged in a corresponding position of the lamp shade and the base. An amount of the light-emitting chips is more than one.

The lamp shade has a light distribution function, and is made of ceramic, glass or other highly thermally-conductive materials with light transmission performance. The outer surface of the lamp shade is designed into a specific shape according to the actual needs. The base is arranged on the power supply chamber, to realize independent heat dissipation. The base can be a metal base coated with an insulating layer, a ceramic base, etc.

### Embodiment 1

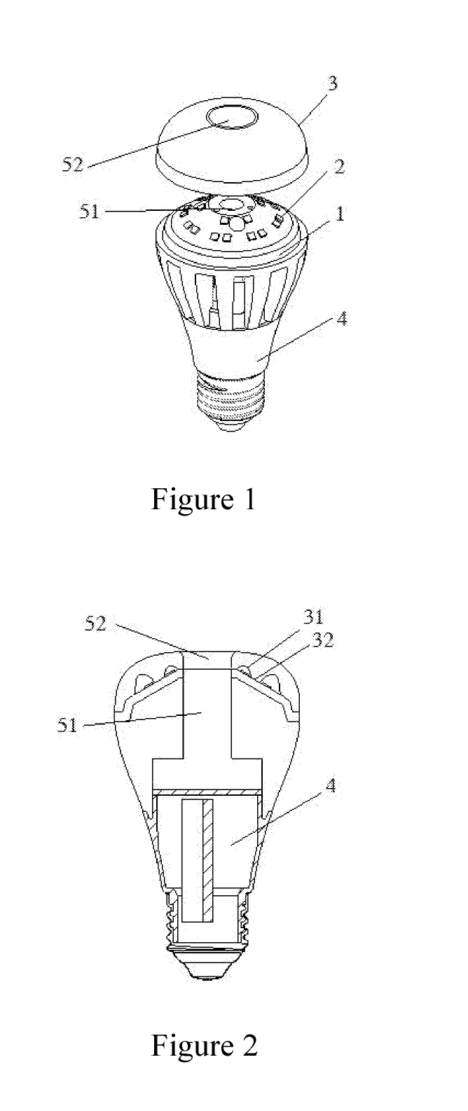

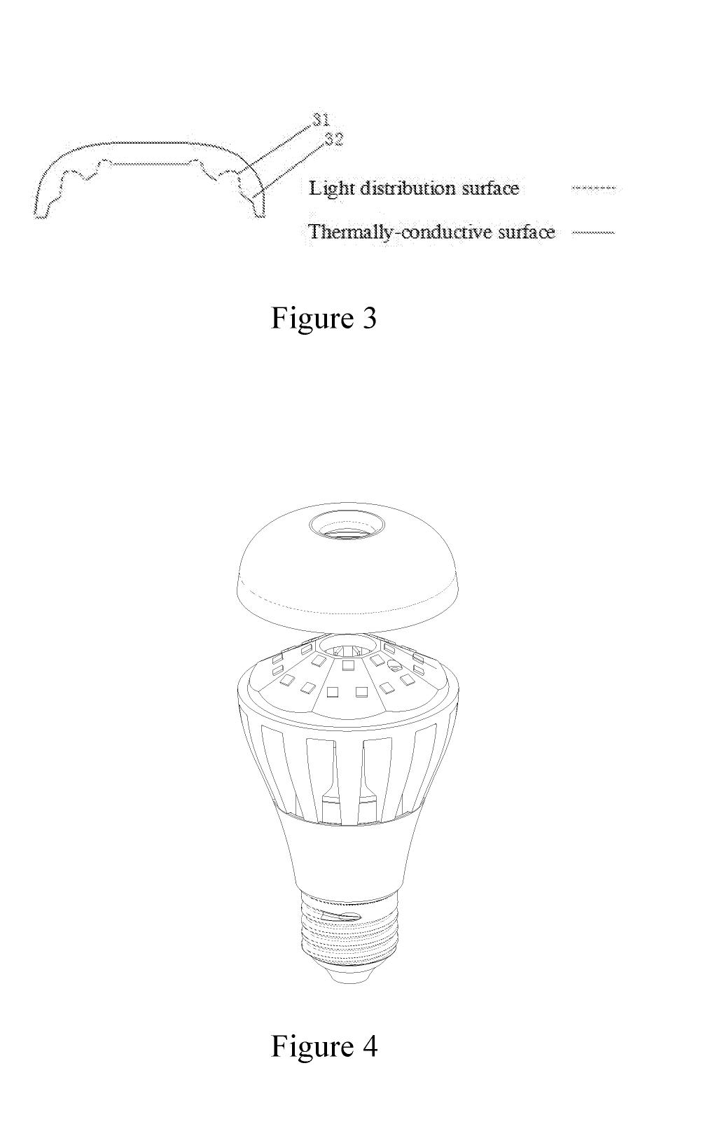

Next, the first embodiment is described in detail with reference to FIG. 1 and FIG. 2.

The novel LED lighting device mainly comprises a base 1, twenty two LED light-emitting chips, a circuit coating and a highly thermally-conductive lamp shade. The base is a ceramic base with a curved upper surface. A first cooling hole is arranged in a middle of the base. The upper surface of the base (except for the cooling holes) is directly coated with circuit coating. The circuit coating is a conductive silver paste. The light-emitting chips are directly attached to the base, and communicated with each other through the circuit coating. The lamp shade is a solid transparent ceramic, which is made of polycrystalline AION. A second cooling hole is arranged in a middle position of the lamp shade corresponding to the first cooling hole of the base, to achieve air circulation. The inner surface of the lamp shade in contact with the base is a curved surface corresponding to a shape of the base. The lamp shade contacts with the base 1 directly, and covers the base to package the LED light-emitting chips and circuit coating inside. The light distribution surface is arranged on the inner surface corresponding to the LED light-emitting chips, but not adhered to the LED light-emitting chips, so as to form a light distribution chamber together with the upper surface of the base. The thermally-conductive surface is at least distributed in a central region and an edge region of the inner surface of the lamp shade, and completely fits with the upper surface of the base, to achieve light transmission and heat dissipation. The base has a completely hollow structure to achieve cross ventilation. The power supply chamber made of ceramic is integrated with the base, but not communicated with the base 1, to realize independent heat dissipation.

### Embodiment 2

Next, a second embodiment is described in detail with reference to FIG. 4.

The LED lighting device mainly comprises a base, twenty seven LED light-emitting chips, a circuit coating and a lamp shade. The base 1 is an aluminum base coated with an insulating material on the upper surface of a multi-bevel shape. The upper surface of the base (except for the cooling holes) is directly coated with circuit coating. The circuit coating is conductive silver-palladium alloy slurry. The LED light-emitting chips are directly attached to the base, and communicated with each other through the circuit coating. The lamp shade is a solid transparent ceramic, which is made of MgAl₂O₄. A second cooling hole is arranged in a middle position of the lamp shade corresponding to the first cooling hole of the base, to achieve air circulation. The inner surface of the lamp shade in contact with the base is in a shape of multi-planar combination. The lamp shade contacts with the base directly, and covers the base to package the LED light-emitting chips and the circuit coating inside. The light distribution surface is arranged on an inner surface corresponding to the LED light-emitting chips, but not adhered to the LED light-emitting chips, so as to form a light distribution chamber together with the upper surface of the base. The thermally-conductive surface is at least distributed in a central region and an edge region of the inner surface of the lamp shade, and completely fits with the upper surface of the base, to achieve light transmission and heat dissipation. The base has a completely hollow structure to achieve cross ventilation. The power supply chamber is made of plastic. As an independent structure, the power supply chamber is not communicated with the base. The base is connected to the power supply chamber in screwing mode, to realize independent heat dissipation respectively. The power supply chamber and the base can be connected in clamping mode or other modes.

Specific embodiments of the invention are described above. It shall be understood that the invention is not limited to the above specific embodiments, and those skilled in the art can make different variants and modifications within the scope of the claims, and it shall not affect the substance of the invention.

What is claimed is:

1. An LED (light-emitting diode) lighting device, comprising a base, a circuit coating, a plurality of light-emitting chips and a lamp shade, wherein the base has a hollow structure; the circuit coating is directly coated on an upper surface of the base; the light-emitting chips are directly adhered to the base, and connected with each other through the circuit coating; the lamp shade is arranged on the base and covers the LED light-emitting chips and the circuit coating; the lamp shade is a solid component made of a thermally-conductive material; the lamp shade has an outer surface and an inner surface; the outer surface is a light exit surface; the inner surface comprises a light distribution surface and a thermally-conductive surface, wherein, the light distribution surface is arranged on an inner surface region corresponding to the LED light-emitting chips; a gap is formed between the light distribution surface and the LED light-emitting chips, to form a light distribution chamber together with the upper surface of the base; the thermally-conductive surface is arranged on an inner surface part other than a part where the LED light-emitting chips are installed on the base, or a region corresponding to the entire upper surface, and closely fits with the base; and the thermally-conductive surface is at least distributed in a central region and an edge region of the inner surface.

2. The LED lighting device according to claim 1, wherein the inner surface of the lamp shade consists of the light distribution surface and the thermally-conductive surface.

3. The LED lighting device according to claim 1, wherein the lamp shade is made of transparent ceramic or glass.

4. The LED lighting device according to claim 3, wherein the transparent ceramic is selected from PLZT (Plomb Lanthanum Zirconate Titanate), CaF₂, Y₂O₃, YAG (Yttrium Aluminum Garnet), polycrystalline AION and MgAl₂O₄.

5. The LED lighting device according to claim 1, wherein the circuit coating is a liquid or powder coating containing metal material; a thickness of the circuit coating is 20 μm or above.

6. The LED lighting device according to claim 5, wherein the metal material of the circuit coating is selected from molybdenum, manganese, tungsten, silver, gold, platinum, silver-palladium alloy, copper, aluminum and tin.

7. The LED lighting device according to claim 1, wherein the upper surface of the base provided with light-emitting chips is curved or in a shape of multi-planar combination.

8. The LED lighting device according to claim 1, wherein the base has a first cooling hole.

9. The LED lighting device according to claim 8, wherein the lamp shade has a second cooling hole, wherein, the second cooling hole is correspondingly communicated with the first cooling hole.

10. The LED lighting device according to claim 1, wherein the base is a metal base coated with an insulating layer, or a base made of an insulating material.

11. The LED lighting device according to claim 1, further comprising a power supply chamber, wherein an outer housing of the power supply chamber is connected to the base; and a cavity of the power supply chamber is isolated from the base.
